(19) United States
(12) Patent Application Publication
(10) Pub. No.: US 2022/0061345 A1
(43) Pub. Date: Mar. 3, 2022

(54) PROCESS FOR PREPARING AN INFANT FORMULA USING FREEZE-DRYING

(71) Applicant: N.V. Nutricia, HM Zoetermeer (NL)

(72) Inventor: Jewe Schröder, CT Utrecht (NL)

(21) Appl. No.: 17/415,493

(22) PCT Filed: Dec. 19, 2019
(86) PCT No.: PCT/EP2019/086258

§ 371 Date: Jun. 17, 2021

(30) Foreign Application Priority Data
Dec. 20, 2018 (EP) 18214657.1

(51) Int. Cl. A23C 1/08; A23L 33/00; A23L 3/44; A23D 7/005; A23D 7/01

(52) U.S. Cl. CPC A23C 1/08; A23L 33/40; A23D 7/011; A23D 7/0053; A23L 3/44

(57) ABSTRACT

The present invention relates to a process for preparing a freeze-dried composition selected from infant formula, follow-on formula or growing up milk, said composition comprises large lipid globules, preferably coated with polar lipids.

### FIELD OF THE INVENTION

The present invention relates to a process for preparing a freeze-dried composition selected from infant formula, follow-on formula or growing up milk.

### BACKGROUND OF THE INVENTION

Human milk is the uncontested gold standard concerning infant nutrition. However, in some cases breastfeeding is inadequate or unsuccessful, due to medical reasons or due to a choice not to breastfeed. For such situations infant or follow on formulas have been developed. Commercial infant formulas are commonly used today to provide supplemental or sole source of nutrition early in life. These formulas comprise a range of nutrients to meet the nutritional needs of the growing infant, and typically include fat, carbohydrate, protein, vitamins, minerals, and other nutrients helpful for optimal infant growth and develo0ent. Commercial infant formulas are designed to mimic, as closely as possible, the composition and function of human milk.

In natural unprocessed mammalian milk, lipids occur primarily as triglycerides contained within emulsified globules with a mode diameter of approximately 4 μm. These globules are surrounded by a structural membrane composed of phospholipids (0.2 to 1 wt. % based on total fat), glycolipids, cholesterol, enzymes, proteins, and glycoproteins.

The major part of the fat component used in known infant or follow-on formulae is of vegetable origin. The use of a large part of cow's milk fat is less desirable, because of a more unfavourable fatty acid profile. Additionally, long-chain polyunsaturated fatty acids of microbial, fish or egg origin are typically added to improve the fatty acid profile. Known infant or follow-on formulae, wherein the fat is mainly of vegetable origin, typically comprise a small amount of polar lipids, such as phospholipids.

In known processes for preparing infant or follow-on formulae the fat or lipid phase comprising lipids and lipid-soluble vitamins is mixed vigorously with the aqueous phase comprising proteins and carbohydrates and the mixture is homogenised under high pressure (typically in a range of 100 to 250 bar in total across one or two valves) by a conventional high pressure homogeniser alone or in combination with a high pressure pump. Thus, during homogenisation the fat phase is compartmentalized into smaller droplets, e.g. below 1 μm, so that it no longer separates from the aqueous phase and collects at the top, which is called creaming. Examples of such known processes are described in WO 2015/086171 or CN107156302.

The homogenisation step results in a stable oil-in-water emulsion, comprising lipid globules with a mode volume-weighted diameter of 0.1 to 0.5 μm. Due to this small globule size, which results in an increased lipid globule surface area, the relatively small amount of polar lipids is not sufficient to ensure that the distribution of the phospholipids corresponds to unprocessed lipid globules. Instead, the amount of protein, in particular casein, covering the lipid globules increases. This is in contrast with the structure of lipid globules in unprocessed or raw milk, such as human milk, wherein the lipid globules are larger and the lipid globules are covered with a milk globule membrane comprising polar lipids in higher quantities than the above described processed IMF (infant milk formula).

Nutritional compositions with vegetable fat having larger lipid globules were also recently found to have long term health benefits with regards to body composition and prevention of obesity later in life. WO 2010/027258 discloses nutritional compositions with vegetable fat having larger lipid globules which are produced by applying a homogenisation step using lower pressure. WO 2010/027259 discloses nutritional compositions with larger lipid globules coated with polar lipids using a homogenisation step with a lower pressure and a higher amount of polar lipids, in particular phospholipids, present before homogenisation.

WO 2013/135738 and WO 2013/135739 disclose processes for preparing infant formulas with larger lipid globules, which are suitable for feeding infants and young children. The processes disclosed therein employ a step of mixing a lipid phase with an aqueous phase so as to obtain a lipid and protein component-containing composition comprising lipid globules wherein only low shear forces are to be applied during the course of the mixing and in particular also of the whole process disclosed. These low shear forces, particularly employed during mixing, are sufficient and necessary to provide lipid globules with the desired particle size distribution. Both documents disclose that subsequent to said mixing step an atomization step may take place so as to spray dry the mixed emulsion. During the spray drying step, the same level of shear forces and at most a shear force as applied during the mixing step shall be used so as not to substantially alter the particle size distribution of the lipid globules obtained by the mixing step. Accordingly, after the mixing step carried out in the homogenization processes, careful processing of the steps after said mixing is required to ensure that the lipid globules keep essentially their size and are not broken down to undesired particle size.

Yao et al., RSC Advances, 2016, 6, 2520-2529 studied the effects of spray drying and freeze-drying on the physical, chemical and structural features of milk fat globules in cow's milk. The globule sizes increased after freeze-drying and spray drying. The drying processes caused a range of structural and physiochemical modifications, which in turn influenced the reconstitution and absorption of milk proteins and caused the increase in milk fat globule sizes.

The technical problem underlying the present invention is therefore to provide an improved process for the preparation of a dried nutritional composition selected from infant formula, follow-on formula or growing up milk comprising large lipid globules.

The technical problem underlying the present invention is therefore also to provide a process for the preparation of a dried nutritional composition selected from infant formula, follow-on formula and growing up milk, resulting in a product comprising large lipid globules but avoiding critical steps, especially such a process, wherein no atomization step is necessary.

These technical problems are solved by the processes and the products according to the independent claims.

### SUMMARY OF THE INVENTION

A first aspect of the present invention provides a process for preparing a freeze-dried composition selected from infant formula, follow-on formula or growing up milk, wherein the freeze-dried composition comprises a protein component, a digestible carbohydrate component, and a lipid, wherein the lipid is present in the form of lipid globules, and wherein the process comprises the steps of:
a) providing:
   i. an aqueous phase comprising at least one digestible carbohydrate component and at least one protein component; and
   ii. a lipid phase comprising a lipid;
b) homogenizing the aqueous phase and lipid phase to obtain an oil-in-water emulsion; and
c) freeze-drying said emulsion to obtain the freeze-dried composition comprising:
   a. lipid globules having a volume-weighted mode diameter of at least 1.0 μm, and/or
   b. lipid globules, wherein at least 40 vol. % of said lipid globules have a diameter from 2 to 12 μm.

Surprisingly, it was found that using a homogenization step in combination with a freeze-drying step results in dry compositions with lipid globules with a suitable size and structure. The present process is further characterised by a very good controllability and reproducibility.

Preferably, lower shear forces are applied during the complete course of the present production process starting from the homogenizing of the aqueous and lipid phases and ending with the freeze-drying. Preferably, high shear forces are already avoided from the point the lipid phase is fed into the aqueous phase, which might occur before or during homogenizing.

The present process, results in the production of lipid globules having a volume-weighted mode diameter closer to the diameter of human milk lipid globules, which may be coated by a membrane of polar lipids, if desired, leading to a further resemblance of milk lipid globules. The composition obtainable, preferably obtained, by the process according to the present invention, thus does resembles human milk with respect to the lipid globule size and architecture.

A second aspect of the present invention provides a freeze-dried composition selected from infant formula, follow-on formula or growing up milk, obtainable by the process as described herein before.

### DETAILED DESCRIPTION OF THE INVENTION

The term “volume-weighted mode diameter” (or mode diameter based on volume) relates to the diameter which is the most present based on volume of total lipid, or the peak value in a graphic representation, having on the x-axis the diameter and on the y-axis the volume in %.

In the context of the present invention, the term ‘volume % (vol. %)’ of lipid globules refers to the volume in percent of a particular population of lipid globules having a particular diameter or diameter range in relation to the overall volume of all lipid globules in the composition, if not stated otherwise.

The volume of the lipid globule and its size distribution can suitably be determined using a particle size analyzer such as a Mastersizer (Malvern Instruments, Malvern, UK), for example by the method described in Michalski et al, 2001, Lait 81: 787-796.

In the context of the present invention, the term “the freeze-dried composition” refers to both the freeze-dried composition as is obtained in step c) in the process according to the first aspect of the invention, as to the freeze-dried composition according to the second aspect of the invention.

In the context of the present invention, the term “high shear force” refers to the forces applied in a process such as high pressure homogenization with pressures in a range of 100 to 250 bar in total across one or two valves.

In the context of the present invention, the term “low shear force” refers to the forces applied in a process such as an inline mixer operating at 4.000 to 20.000 RPM.

In the context of the present invention, the term “the present process” preferably encompasses a process with process steps a), b), c), and, if applied, an optional premixing step of the aqueous phase and lipid phase after process step a) and before conducting process step b). Preferably, the present process consists of process steps a), b) and c). Preferably in the alternative, the present process consists of step a), premixing the aqueous phase and lipid phase, step b) and step c).

In this document and in its claims, the verb “to comprise” and its conjugations is used in its non-limiting sense to mean that items following the word are included, but items not specifically mentioned are not excluded. In addition, reference to an element by the indefinite article “a” or “an” does not exclude the possibility that more than one of the element is present, unless the context clearly requires that there be one and only one of the elements. The indefinite article “a” or “an” thus usually means “at least one”.

Step a) Providing an Aqueous Phase and a Lipid Phase

According to the invention the aqueous phase comprises at least one digestible carbohydrate component. Preferred digestible carbohydrate components are lactose, glucose, sucrose, fructose, galactose, maltose, starch and maltodextrin. Lactose is the main digestible carbohydrate present in human milk. Thus, the aqueous phase preferably comprises lactose.

The aqueous phase preferably comprises at least 35 wt. % lactose, more preferably at least 50 wt. % lactose, more preferably at least 75 wt. % lactose, even more preferably at least 90 wt. % lactose, most preferably at least 95 wt. % lactose, by dry weight of the digestible carbohydrate component. Based on dry weight, the aqueous phase preferably comprises at least 25 wt. % lactose, preferably at least 40 wt. % lactose.

According to the invention the aqueous phase comprises at least one protein component. In the context of the present invention the term “protein component” refers to proteinaceous matter in general, which includes proteins, peptides, free amino acids but also compositions comprising proteins, peptides and/or free amino acids, i.e. sources of protein.

In a preferred embodiment of the invention the protein component is selected from the group consisting of skim milk, skim milk powder, whey, whey powder, whey protein, whey protein isolate, whey protein hydrolysate, casein, casein hydrolysate and soy protein.

The source of the protein component, is preferably selected in such a way that the minimum requirements of an infant for essential amino acid content are met and satisfactory growth is ensured. Hence, protein components comprising non-human mammalian milk proteins, such as whey protein, casein and mixtures thereof, or protein components comprising plant proteins, such as soy, potato or pea protein, are preferred. In case whey proteins are used, the protein component preferably comprises acid whey, sweet whey, whey protein isolate or mixtures thereof and preferably includes α-lactalbumin and β-lactoglobulin.

In a preferred embodiment, the protein component comprises a mixture of casein and whey protein, more preferably a mixture of casein and whey protein in a weight ratio of between 5:1 and 1:5, more preferably in a weight ratio of between 2:1 and 2:1.

The aqueous phase preferably comprises at least 3 wt. % protein, more preferably at least 5 wt. % protein and most preferably at least 8 wt. % protein, by dry weight of the aqueous phase.

In a preferred embodiment of the invention the aqueous phase further comprises one or more components selected from the group consisting of non-digestible carbohydrates, vitamins and minerals. In a more preferred embodiment the aqueous phase further comprises one or more components selected from the group consisting of non-digestible carbohydrates, vitamins, trace elements and minerals.

All components in the freeze-dried composition according to the invention preferably are within the concentration ranges according to international directives for infant formulae.

Preferably, the aqueous phase further comprises at least one non-digestible oligosaccharide, preferably a non-digestible oligosaccharide with a degree of polymerization (DP) from 2 to 250, more preferably with a DP from 3 to 60. The non-digestible oligosaccharide is preferably selected from the group consisting of fructooligosaccharides, such as inulin, galactooligosaccharides, such as trans-galactooligosaccharides or beta-galactooligosaccharides, and/or uronic acid oligosaccharides. More preferably the non-digestible oligosaccharide is selected from the group consisting of fructooligosaccharides and/or galactooligosaccharides. Most preferably, the non-digestible oligosaccharide is a combination of fructooligosaccharides and galactooligosaccharides.

Based on dry weight, the aqueous phase preferably comprises 0.25 wt. % to 20 wt. %, more preferably 0.5 wt. % to 10 wt. %, most preferably 1.5 wt. % to 7.5 wt. % of at least one non-digestible oligo-saccharide.

To prepare the aqueous phase, hereinafter also called “compounding of the aqueous phase”, the at least one protein component, the at least one digestible carbohydrate component and the above described optional further components are preferably compounded in the aqueous phase, in particular an aqueous medium, preferably water. For this compounding of the aqueous phase the at least one protein component and the at least one digestible carbohydrate as well as all other optional components may be in a dry state or present as solutions or suspensions. Preferably said components are provided in the desired dry matter content.

In a preferred embodiment of the invention, the aqueous phase is provided with a dry matter content of 5-75 wt. % by weight of the aqueous phase. More preferably the aqueous phase is provided with a dry matter content of 10 to 60 wt. %, preferably 15 to 55 wt. %, more preferably 20 to 50 wt. %, even more preferred 25 to 50 wt. % and most preferred 30 to 50 wt. %, by weight of the aqueous phase. It is furthermore preferred to provide the aqueous phase with a dry matter content of 30 to 60 wt. %, preferably 35 to 55 wt. %, more preferably 40 to 50 wt. %, by weight of the aqueous phase.

In case the aqueous phase comprising the at least one protein component, the at least one digestible carbohydrate component and optional further components is provided with a dry matter content below 40 wt. %, such as 25%, it may be preferred to concentrate, preferably evaporate, said aqueous phase, preferably by using an evaporator, prior to step a) of the present process to yield a higher dry matter content.

The preferred evaporation step can be performed on the aqueous phase or, in an alternative embodiment, on the mixture of the aqueous and lipid phase, preferably after homogenisation.

Preferably, after compounding all required components in the aqueous phase the pH of the aqueous phase is adjusted to between 6.0 to 8.0, more preferably to between 6.5 to 7.5.

Optionally, the aqueous phase is filtered by appropriate means to prevent an entering of foreign bodies, for instance impurities or pathogens, into the process.

During compounding of the aqueous phase the employed shear forces are not critical. Thus, the aqueous phase may be compounded using high shear forces.

Optionally, the aqueous phase is pasteurised or heat treated first by a preheating step, wherein the aqueous phase is heated to 60 to 100° C., preferably to 70 to 90° C., more preferably to 85° C. with a holding time of 1 second to 6 minutes, more preferably 10 seconds to 6 minutes, even more preferably 30 seconds to 6 minutes. This leads to a pre-sterilisation of the aqueous phase.

In a preferred embodiment of the invention, the aqueous phase is sterilized or pasteurised before the homogenizing in step b). In an alternative preferred embodiment of the invention, a sterilized or pasteurised aqueous phase is provided in step a).

In a preferred embodiment, preferably after heating, the aqueous phase preferably undergoes a high heat treatment (HHT), wherein it is heated to temperatures over 100° C., preferably 120 to 130° C., most preferred to 124° C. This temperature is preferably held for about 1 to 4 seconds, more preferably for about 2 seconds.

Preferably, the HHT is performed prior to an optionally performed concentration step, preferably prior to an optionally performed evaporation step.

In a preferred embodiment of the present invention the HHT is performed on the aqueous phase alone. Accordingly, the lipid phase is added thereafter resulting in the mixing and homogenisation of the aqueous and lipid phase. In another embodiment of the present invention the HHT is performed on the mixture of the aqueous and lipid phase.

Alternatively, other suitable methods of pasteurisation or sterilisation can be applied. Several pasteurization and sterilisation methods are known in the art and are commercially feasible.

In step a) of the process a lipid phase, which comprises at least one lipid is provided, preferably at least one vegetable lipid. The presence of vegetable lipids advantageously enables an optimal fatty acid profile, high in (poly)unsaturated fatty acids and/or more reminiscent to human milk fat. Using lipids from cow's milk alone, or other domestic mammals, provides not in any case an optimal fatty acid profile. In particular, such a less optimal fatty acid profile, relatively high in saturated fatty acids, is known to result in increased obesity and a too low content of essential fatty acids.

Preferably, the at least one lipid, preferably vegetable lipid, contained in the lipid phase is selected from the group consisting of linseed oil, flaxseed oil, rape seed oil (such as colza oil, low erucic acid rape seed oil and canola oil), salvia oil, perilla oil, purslane oil, lingonberry oil, sea buckthorn oil, hemp oil, sunflower oil, high oleic sunflower oil, safflower oil, high oleic safflower oil, olive oil, black currant seed oil, echium oil, coconut oil, palm oil and palm kernel oil. Preferably a part of the lipid, is milk fat, more preferably anhydrous milk fat and/or butter oil. Commercially available lipids, preferably vegetable lipids, for use in the present invention preferably are in the form of a continuous oil phase.

Preferably, the lipid phase comprises 50 to 100 wt. % vegetable lipids by weight of total lipids, more preferably 70 to 100 wt. %, even more preferably 75 to 97 wt. % vegetable lipids, by weight of total lipids. Preferably, the lipid phase comprises at least 75 wt. %, more preferably at least 85 wt. %, even more preferably at least 95 wt. % triglycerides by weight of total lipids.

Preferably, the lipid phase comprises further components such as fat-soluble vitamins, preferably according to international directives for infant formulae.

According to the present invention, it is preferred that the lipid phase is liquid at the temperature(s) used during steps a) and b). However, if the lipid phase is solid due to its composition it is preferably heated to above the melting temperature of the lipid contained in the lipid phase. In a preferred embodiment of the present invention, the lipid phase is heated to a temperature above its melting point, preferably to a temperature of 40 to 80° C., preferably 50 to 70° C., more preferably to 55 to 60° C. thereby resulting in a liquid lipid phase. Most preferably, the lipid phase is heated to a temperature of at least 40° C., preferably at least 45° C., more preferably at least 50° C., most preferred to at least 55° C.

If required, the lipid phase is preferably filtered by appropriate filtration devices prior to the next step, preferably step b), to prevent foreign bodies, for instance impurities or pathogens, from entering the production process.

Optional Pre-mixing Step

In an alternative embodiment, the present invention relates to a process according to the above, wherein the lipid phase provided in step a) is premixed with the aqueous phase provided in step a) prior to homogenization step b). Such a premixing step aims to provide a pre-emulsion. A suitable pre-mixer for the premixing step is for example a centrifugal pump or a static mixer—or a batch mixer, in particular a propeller mixer, in case of a batch process. The premixing step is preferably carried out under low shear force as defined herein. In a preferred embodiment of the present invention the lipid phase is fed into the aqueous phase with low pressure, preferably at most 10 bar, more preferably at most 8 bar.

In an alternative preferred embodiment, premixing takes place during injection of the lipid phase into the aqueous phase without using a premixer. Preferably, this is realised using a dosing pump. In particular, the dosing pump injects or feeds the lipid phase into the aqueous phase in such a way that a turbulence is created in the aqueous phase, which leads to premixing of the two phases resulting in a coarse pre-emulsion. Preferably, the dosing pump applies low pressure, in particular the pressure is below 10 bar, more preferably below 8 bar.

Advantageously, premixing ensures that both, the aqueous phase and the liquid lipid phase, are fed in the right quantities into the homogenization step b). Since the resulting lipid droplets are still too large, no stable emulsion is formed during premixing.

In a preferred embodiment, the aqueous phase, the lipid phase or most preferably both phases are prior to the premixing step heated to a temperature from 40° C. to 90° C., preferably 50° C. to 80° C., preferably of 70° C.

Step b) Homogenization

According to the invention, after the provision of the aqueous phase and the lipid phase in step a) of the process and the facultative premixing of the two phases, the two phases are homogenized is step b).

In an embodiment of the present process the aqueous phase and lipid phase are either mixed during the optional premixing step or during the homogenization step b). Preferably the mixing is conducted at a ratio of 3 to 50% (w/w), preferably 4 to 40% (w/w), preferably 5 to 30% (w/w), preferably 7.5 to 25% (w/w), preferably 10 to 20% (w/w) lipid phase to aqueous phase. Most preferably, the mixing is conducted at a ratio of 5 to 50% (w/w), preferably 10 to 40% (w/w), more preferably 15 to 30% (w/w) lipid phase to aqueous phase. In the context of the present invention, a ratio of X to Y% (w/w) A to B refers to a ratio from X parts A: (100-X) parts B to Y parts A: (100-Y) parts B, e.g. 5 to 50% refers to a ratio from 5 parts lipid phase: 95 parts aqueous phase to 50 parts lipid phase: 50 parts aqueous phase.

The homogenization step b) is preferably carried out with a homogenization apparatus selected from a static mixer, an inline mixer, a rotor stator machine, a cavitator or by a membrane emulsification device. More preferably, the homogenizing in step b) is carried out an inline mixer, more preferably the homogenizing is carried out with an inline rotor stator machine.

The homogenization apparatus in step b) of the present process, preferably exerts homogenization at a low shear force.

In the present process it is preferred to avoid high shear forces. Thus, it is preferred to use a low shear force, preferably at least from the fat injection point onwards, that means during and/or after the step of feeding the lipid phase into the aqueous phase, e.g. prior to or during homogenization step b).

Thus, the present process preferably and advantageously does not involve high pressure and/or high energy input homogenisation devices. This is advantageous in so far as homogenisers typically used for such processes exert high shear forces such as resulting from pressures of 100 to 250 bar in total across one or two valves in conventional homogenizers, whereas the homogenization apparatus, such as used in the present process only applies low shear forces.

Dynamic high pressure is conventionally used in the food industry and is sometimes also referred to as high pressure valve homogenization. In a preferred embodiment of the present invention, the present process does not use a dynamic high pressure homogeniser or a dynamic high pressure homogenisation step. In a preferred embodiment of the present invention, the present process does not use a dynamic high pressure one-step homogeniser or a dynamic high pressure one-step homogenisation process. In a preferred embodiment of the present invention, the present process does not use a dynamic high pressure two-step homogeniser or a dynamic high pressure two-step homogenisation process.

In a preferred embodiment the oil-in-water emulsion is obtained in step b) at a pressure of at most 1 MPa (10 bar), preferably below 1 MPa (10 bar), preferably at most 0.8 MPa (8 bar), preferably below 0.8 MPa (8 bar), more preferably at most 0.7 MPa (7 bar), preferably below 0.7 MPa (7 bar).

In a particularly preferred embodiment of the present process the oil-in-water emulsion obtained in step b) can then be reheated to 75 to 85° C., preferably 78 to 80° C. to further reduce, preferably completely eliminate pathogenic bacteria.

In a preferred embodiment of the invention the dry matter content of the oil-in-water emulsion is at least 30 wt. % by weight of the emulsion, preferably at least 40 wt. %, more preferably at least 50 wt. %

and most preferably between 55-80 wt. % by weight of the emulsion. The present process enables for the use of a higher dry matter content of the emulsion to be homogenized, and accordingly freeze-dried. This significantly increases the capacity of the freeze-dryer.

The homogenization step b) is preferably conducted in such a way that a lipid globule size distribution, as disclosed herein for the lipid globules in the obtained freeze-dried composition, is obtained in step b). Therefore, the obtained oil-in-water emulsion in step b) preferably comprises:
a) lipid globules having a volume-weighted mode diameter of at least 1.0 μm, and/or
b) lipid globules, wherein at least 40 vol. % of said lipid globules have a diameter from 2 to 12 μm.

Preferably, the lipid globules in the oil-in-water emulsion obtained in step b), have a volume-weighted mode diameter of at least 1 μm, preferably of at least 2 μm, more preferably of at least 3 μm, most preferred of at least 3.5 μm, even more preferably about 4 μm. Preferably, the volume-weighted mode diameter of the lipid globules in the oil-in-water emulsion obtained in step b), is below 20 μm, preferably below 15 μm, more preferably below 12 μm, even more preferably below 10 μm and most preferably below 7 μm. Preferably, the lipid globules in the oil-in-water emulsion obtained in step b), have a volume-weighted mode diameter from 1 to 20 μm, preferably 1.5 to 10 μm, preferably from 2 to 9 μm, more preferably from 3 to 8 μm, most preferred from 4 to 7 μm.

In a preferred embodiment of the invention, at least 40 vol. % of the lipid globules in the oil-in-water emulsion obtained in step b), have a diameter from 2 to 12 μm, more preferably at least 45 vol. %, more preferably at least 55 vol. %, even more preferably 65 vol. % and most preferably at least 75 vol. % of the lipid globules has a diameter between 2 to 12 μm. In a more preferred embodiment of the invention, at least 40 vol. % of the lipid globules in the oil-in-water emulsion obtained in step b), have a diameter from 4 to 10 μm, more preferably at least 45 vol. %, more preferably at least 55 vol. %, even more preferably 65 vol. % and most preferably at least 75 vol. % of the lipid globules has a diameter between 4 to 10 μm. Preferably less than 5 vol. % of the lipid globules in the oil-in-water emulsion obtained in step b) has a diameter above 12 μm.

Step c) Freeze-dryinq Step

According to the invention the homogenization step b) is followed by freeze-drying step c). In a preferred embodiment of the invention the freeze-drying step follows directly the homogenization step. Accordingly, there is preferably only one homogenization step in the process.

Furthermore, no atomization step (i.e. spray drying step) is needed. Therefore, according to a preferred embodiment of the invention the process comprises no atomization step.

It is an advantage of the present invention that the process can be carried out as a one-step-process for generating lipid globules in the preferred size, i.e. there is only one homogenization step needed without an additional second step for generating the desired lipid globules size. A one-step-process also results in an efficient operation, especially in a large-scale factory.

Preferably, during the freeze-drying step no further adaption of the lipid globules size is necessary, therefore a normal freeze-drier may be used.

Advantageously, the lipid globule size distribution is preserved after the freeze-drying step, in particular after subsequent reconstitution in an aqueous medium. Thus, upon reconstitution with water the freeze-dried composition still displays these features.

It is a further advantage of the present invention that the volume-weighted mode diameter of the lipid globules changes due to the freeze-drying only slightly, particularly the volume-weighted mode diameter of the lipid globules increases due to the freeze-drying only slightly. Therefore the skilled person can easily control the desired volume-weighted mode diameter of the lipid globules by the homogenization step, e.g. by generating a lipid globule size distribution with a volume-weighted mode diameter in homogenization step b) that is between 0.1 and 1.6 μm, preferably between 0.2-1.2 μm, more preferably between 0.3-0.8 μm lower than the desired volume-weighted mode diameter of the freeze-dried composition obtained in step c).

Furthermore, the heat load on the emulsion and the resulting freeze-dried composition is lower compared to the heat load of a spray drying step, which is common in the state of the art, on the emulsion and the resulting spray-dried composition. Heat sensitive ingredients, such as vitamins, have a higher retention rate in freeze-dried compositions.

In a preferred embodiment of the invention the freeze-drying in step c) encompasses:
c1) freezing the oil-in-water emulsion to obtain a frozen emulsion; and
c2) drying the frozen emulsion at a pressure of less than 6 mbar and at a temperature from 0° C. and 60° C.

Freezing step c1) (crystallization) is followed by the drying step c2), during which at reduced pressure the frozen solvent is converted from the solid to the gaseous aggregate state, that is to say is sublimated. The energy which is consumed during sublimation may be supplied, for example, via heatable adjustable shelves. During the sublimation in drying step c2) the frozen emulsion may not heat up above its melting point. The drying step c2) also encompasses the removal of nonfrozen solvent (desorption), such as water. This involves nonfrozen solvent which may be, for example, adsorbed on the solid matrix, or enclosed in amorphous areas.

Suitable freeze-drying methods and parameters are known to the skilled person.

In a preferred embodiment of the invention the oil-in-water emulsion is frozen in step c1) by cooling to a temperature of 0° C. or lower, preferably to a temperature of −4° C. or lower, more preferably to a temperature of −10° C. or lower, even more preferably to a temperature of −15° C. or lower, most preferably to a temperature between −20° C. and −80° C.

In a preferred embodiment of the invention the pressure in drying step c2) is at most 5 mbar, preferably at most 4 mbar, more preferably at most 3 mbar and most preferably at most 2 mbar. In a preferred embodiment of the invention the pressure in drying step c2) is at least 0.001 mbar, more preferably at least 0.005 mbar and most preferably at least 0.01 mbar. In a more preferred embodiment of the invention the pressure in drying step c2) is from 0.001 to 2 mbar.

In a preferred embodiment of the invention, the temperature during the drying step c2) is from 1° C. to 50° C., more preferably from 2° C. to 40° C.

In a preferred embodiment of the invention, the drying step c2) is done for at least 1 hour to at most 48 hours, more preferably for at least 4 hours to at most 24 hours.

Preferably, the obtained freeze-dried composition may then be filled in appropriate containers. Thus, the freeze-dried composition is preferably in solid form, more preferably in powdered form after grinding.

In a particularly preferred embodiment, the further components which are already present in dry form, such as some minerals, vitamins, and non-digestible oligosaccharides, may be dry-blended into the freeze-dried composition, before the freeze-dried composition is filled into containers.

In case ingredients specified herein to be added either to the aqueous or the lipid phase are sensitive to the temperature(s) or conditions employed during any of the steps of the process according to the present invention they might also be added at a later point in the process, such as after homogenizing and before freeze-drying or even after freeze-drying.

Freeze-dried Composition

In the first aspect of the invention a freeze-dried composition is obtained in step c) of the process of the invention.

A second aspect of the invention pertains to a freeze-dried composition selected from infant formula, follow-on formula or growing up milk, obtainable by the process as described herein before. Preferably this freeze-dried composition is obtained by the process as described herein before.

Accordingly, the freeze-dried composition may have the components, as outlined for the process as described herein before, and in the amounts, as outlined for the process as described herein before.

The freeze-dried composition is an infant formula, a follow-on formula or a growing up milk. Thus, preferably, the freeze-dried composition is a powder suitable for making a liquid composition after reconstitution with an aqueous solution, preferably water, to form a ready-to-feed liquid. Preferably, the freeze-dried composition is reconstituted, preferably with water, just prior to consumption. This will ensure stability of the emulsion, although a little bit of creaming may occur due to the larger lipid globules of the present composition. A small amount of creaming is beneficial since this closely resembles the conditions of breast feeding. It was found that lipid globules maintained their size and coating when reconstituted.

Thus, the freeze-dried composition is preferably administered to a human subject with an age of at most 36 months, preferably of at most 18 months, more preferably of at most 12 months, even more preferably of at most 6 months. Preferably, the freeze-dried composition is suitable and prepared for providing the daily nutritional requirements to a human subject with an age as defined herein before.

In a preferred embodiment of the invention the freeze-dried composition comprises by dry weight of the composition 20 to 80 wt. % of a digestible carbohydrate component, 10 to 50 wt. % of lipid, and 5 to 20 wt. % of a protein component.

Based on dry weight, the freeze-dried composition, preferably comprises 20 to 80 wt. %, more preferably 30 to 70 wt. % and most preferably 40 to 65 wt. % of digestible carbohydrate component.

The digestible carbohydrate component preferably provides 30 to 80%, preferably 40-60% of the total calories of the composition.

When in liquid form, for instance as a ready-to-feed liquid, the composition preferably comprises 3 to 30 g digestible carbohydrate component per 100 ml, more preferably 6 to 20 g, even more preferably 7 to 10 g per 100 ml.

Based on dry weight, the freeze-dried composition preferably comprises 10 to 50 wt. %, more preferably 12.5 to 45 wt. %, preferably 15 to 40 wt. %, even more preferably 19 to 30 wt. % lipid.

When in liquid form, for instance as a ready-to-feed liquid, the composition preferably comprises 2.1 to 6.5 g lipid per 100 ml, more preferably 3.0 to 4.0 g lipid per 100 ml.

Based on dry weight, the composition preferably comprises less than 12 wt. % protein, more preferably between 9.6 to 12 wt. % protein, even more preferably 10 to 11 wt. % protein.

Preferably, the protein component provides 5 to 15%, more preferably 6 to 12% of the total calories. More preferably protein is present in the composition of at most 9% based on calories, more preferably the composition comprises between 7.2 and 8.0% protein based on total calories, even more preferably between 7.3 and 7.7% based on total calories. A low protein concentration advantageously ensures a lower insulin response, thereby preventing proliferation of adipocytes in infants. Human milk comprises a lower amount of protein based on total calories compared to cow's milk.

When in liquid form, for instance as a ready-to-feed liquid, the composition preferably comprises less than 1.5 g protein per 100 ml, more preferably between 1.2 and 1.5 g protein per 100 ml, even more preferably between 1.25 and 1.35 g protein per 100 ml, upon reconstitution. The protein concentration in the composition is determined by the sum of protein, peptides and free amino acids.

When in liquid form, for instance as a ready-to-feed liquid, to meet the caloric requirements of the human subject, the preferably comprises 50 to 200 kcal/100 ml, more preferably 60 to 90 kcal/100 ml, even more preferably 60 to 75 kcal/100 ml, upon reconstitution. This caloric density ensures an optimal ratio between water and calorie consumption.

When in liquid form, for instance as a ready-to-feed liquid, the osmolality of the composition is preferably between 150 and 420 mOsmol/l, more preferably 260 to 320 mOsmol/l. The low osmolality aims to reduce the gastrointestinal stress.

When in liquid form, for instance as a ready-to-feed liquid, the composition has a viscosity of at most 35 mPa.s, more preferably at most 6 mPa.s, as measured in a Brookfield viscometer at 20° C. at a shear rate of 100 s-1.

Lipid Globule Size

The freeze-dried composition comprises lipid globules having a volume-weighted mode diameter of at least 1.0 μm, and/or comprises lipid globules, wherein at least 40 vol. % of said lipid globules have a diameter from 2 to 12 μm.

Preferably, the lipid globules, also called lipid droplets, of the freeze-dried composition have a volume-weighted mode diameter of at least 1 μm, preferably of at least 2 μm, more preferably of at least 3 μm, most preferred of at least 3.5 μm, even more preferably about 4 μm. Preferably, the volume-weighted mode diameter is below 20 μm, preferably below 15 μm, more preferably below 12 μm, even more preferably below 10 μm and most preferably below 7 μm. Preferably, the lipid globules of the freeze-dried composition have a volume-weighted mode diameter from 1 to 20 μm, preferably 1.5 to 10 μm, preferably from 2 to 9 μm, more preferably from 3 to 8 μm, most preferred from 4 to 7 μm.

In a preferred embodiment of the invention, at least 40 vol. % of the lipid globules of the freeze-dried composition have a diameter from 2 to 12 μm, more preferably at least 45 vol. %, more preferably at least 55 vol. %, even more preferably 65 vol. % and most preferably at least 75 vol. % of the lipid globules has a diameter between 2 to 12 μm. In a more preferred embodiment of the invention, at least 40 vol. % of the lipid globules of the freeze-dried composition have a diameter from 4 to 10 μm, more preferably at least 45 vol. %, more preferably at least 55 vol. %, even more preferably 65 vol. % and most preferably at least 75 vol. % of the lipid globules has a diameter between 4 to 10 μm. Preferably less than 5 vol. % has a diameter above 12 μm.

Polar Lipids

The lipid globules of human milk comprise a globule membrane which comprises polar lipids, in particular phospholipids. Thus, it is desirable to provide an infant formula comprising lipid globules comprising a coating of polar lipids, preferably phospholipids.

By “coated” or “coating” is meant that the outer surface layer of the lipid globule comprises polar lipids, whereas these polar lipids are virtually absent from the core of the lipid globule. The presence of polar lipids as a coating or outer layer of the lipid globule resembles the structure of lipid globules of human milk.

Thus, in a particularly preferred embodiment of the present process, the lipid phase and/or the aqueous phase comprise polar lipids, preferably comprise added polar lipids. When polar lipids are present in either the aqueous phase or the lipid phase or in both, the lipid globules become coated with the polar lipids during the homogenization step b).

If the polar lipids are relatively pure, i.e. do not contain significant quantities of other components, such as soy lecithin, they are preferably added to the lipid phase. In case the polar lipids are impure, i.e. relatively impure and therefore contain significant quantities of other components which are not dissolvable in the fat or lipid phase, such as when they are present in butter milk serum powder, they are preferably added to the aqueous phase.

In a preferred embodiment of the invention the aqueous phase, lipid phase or both comprise polar lipids. Most preferred, the polar lipids are comprised in the aqueous phase.

In a preferred embodiment, the polar lipids are added into the aqueous or the lipid phase or both provided in step a) of the present process. In an alternative preferred embodiment, the polar lipids may also be added during the optional pre-mixing step or during the homogenization step b).

In a preferred embodiment of the invention, the polar lipids are selected from phospholipids, glycosphingolipds and cholesterol. Polar lipids preferably comprise at least phospholipids. Preferably, the freeze-dried composition comprises 0.5 to 20 wt. % polar lipids based on total lipid, more preferably 0.5 to 10 wt. %, more preferably 1 to 10 wt. %, even more preferably 2 to 10 wt. % even more preferably 3 to 8 wt. % polar lipids based on total lipid.

Preferred sources for providing the polar lipids are egg lipids, milk fat, buttermilk fat and butter serum fat, such as beta serum fat. A preferred source for polar lipids, particularly PC (phosphatidylcholine), is soy lecithin and/or sunflower lecithin. The sources preferably comprise polar lipids derived from milk. Preferably, the sources comprise phospholipids and glycosphingolipids derived from milk.

Suitable commercially available sources for milk polar lipids are BAEF, SM2, SM3 and SM4 powder of Corman, Salibra of Glanbia, and LacProdan MFGM-10 or PL20 from Arla. Preferably at least 25 wt. %, more preferably at least 40 wt. %, most preferably at least 75 wt. % of the polar lipids is derived from milk polar lipids.

Preferably, the polar lipids are located on the surface of the lipid globules, that means as a coating or outer layer after the homogenization step b) of the present process. This advantageously also leads to a more stable emulsion, which is especially important when the emulsion contains large lipid globules. A suitable way to determine whether the polar lipids are located on the surface of the lipid globules is laser scanning microscopy.

The concomitant use of polar lipids derived from non-human mammalian milk and triglycerides derived from vegetable lipids enables to manufacture coated lipid globules in the freeze-dried composition, with a coating more similar to human milk, while at the same time providing an optimal fatty acid profile.

The lipid globules in the freeze-dried composition produced by the present process preferably comprise a core and preferably a coating, wherein the core comprises a lipid component. Preferably, the core comprises at least 90 wt. % triglycerides, more preferably consists of triglycerides.

The coating preferably comprises polar lipids, wherein not all polar lipids that are contained in the freeze-dried composition need to be comprised in the coating. Preferably, at least 50 wt. %, more preferably at least 70 wt. %, even more preferably at least 85 wt. %, most preferred more than 95 wt. % of the polar lipids, present in the freeze-dried composition are comprised in the coating of the lipid globules.

Also, not all lipids, present in the freeze-dried composition, necessarily need to be comprised in the core of the lipid globules. Preferably, at least 50 wt. %, more preferably at least 70 wt. %, even more preferably at least 85 wt. %, even more preferably at least 95 wt. %, most preferred more than 98 wt. % of the lipids, comprised in the freeze-dried composition, are comprised in the core of the lipid globules.

Further preferred embodiments of the present invention are subject of the sub-claims.

The invention is further described by way of the following example.

### EXAMPLE

### Example 1

An infant formula was prepared, comprising by dry weight, 12.1 wt. % protein, which was a 50:50 wt. % mixture of casein and demineralised whey respectively, 26.5 wt. % fat (a vegetable oil blend), 52.4 wt. % carbohydrates besides galactooligosaccharides, 6.2 wt. % galactooligosaccharides and 2.9 wt. % vitamins, minerals, trace elements as known in the art.

An aqueous phase, comprising the water-soluble ingredients, was prepared as known in the art and was heat treated to prevent bacterial contamination, namely by a pasteurization treatment, as known in the art. The mixture was heated to between 50 and 60° C. The dry matter content of the aqueous phase was between 43 and 44 wt. %.

A lipid phase, comprising the lipid soluble ingredients, was prepared as known in the art. The vegetable oil blend was also heated to between 50 and 80° C. and added to the aqueous phase. The total solid content of the lipid and aqueous phase mixture was around 51 to 52 wt. %.

The lipid and aqueous phase was premixed using a low shear propeller stirrer.

Accordingly, the aqueous and lipid phase pre-mixture was fed into the inline mixer (IKA Process Pilot 2000/4) comprising one mixing head. The rotor stator design of the inline mixer had 2 stages—one with 1 rows of teeth and one with 3 rows of teeth. The aqueous and lipid phase pre-mixture was mixed at 11,500 rpm at 350 l/h in order to emulsify the lipid phase into the aqueous phase and to obtain an oil-in-water emulsion.

The concentration of the obtained emulsion was increased by evaporation to between 55 and 60% wt. %.

The obtained, concentrated emulsion was not frozen (sample A) or frozen to either a temperature of around −20° C. (sample B and 1) or a temperature of −80° (sample C and 2). The samples frozen at −80° C. were moved after approx. 1.5 h to the −20° C. freezer as no effect of the storage temperature is expected. Freeze-drying was subsequently applied to sample 1 and 2. An overview of the samples is provided in Table 1.

TABLE 1
Overview of the different samples

| Sample | Frozen: | Freeze-drying applied: |
|---|---|---|
| A | No | No |
| B | −20° C. | No |
| C | −80° C. | No |
| 1 | −20° C. | Yes |
| 2 | −80° C. | Yes |

Freeze-drying was performed with a FTSlab freeze-dryer (ilShin FD8510) at around 5 mTorr (≈0.0066 mbar) and +30° C. tray temperature.

The lipid globule size distribution of the different samples was measured with a Malvern Mastersizer 2000 (Malvern Instruments, Malvern UK). Sample A was measured on the day of the preparation of the infant formula. The frozen samples B and C were defrosted before measurement and the freeze-dried samples 1 and 2 were reconstituted (4 g sample in 40 g of tap water at 40° C.) before measurement and all these samples were measured on the same day. Table 2 shows the lipid globule size distribution of different samples.

TABLE 2
Lipid particle size distribution of the different samples

| | vol. % with a diameter | Volume-weighted mode |
|---|---|---|
| Sample | between 2-12 μm | diameter (μm) |
| A | 52.85 | 4.03 |
| B | 53.99 | 4.11 |
| C | 53.47 | 4.15 |
| 1 | 48.86 | 4.72 |
| 2 | 47.06 | 4.92 |

The volume-weighted mode diameter of all samples was above 4.0 μm and below 5.0 μm. In all samples at least 40 vol. % of the lipid globules had a diameter between 2 and 12 μm. This shows that the effect of freeze-drying on the lipid globule size distribution in samples 1 and 2 is limited.

1. A process for preparing a freeze-dried composition selected from infant formula, follow-on formula or growing up milk, wherein the freeze-dried composition comprises a protein component, a digestible carbohydrate component, and a lipid, wherein the lipid is present in the form of lipid globules, and wherein the process comprises the steps of:
a) providing:
i. an aqueous phase comprising at least one digestible carbohydrate component and at least one protein component; and
ii. a lipid phase comprising a lipid;
b) homogenizing the aqueous phase and lipid phase to obtain an oil-in-water emulsion, wherein the oil-in-water emulsion obtained in step b) comprises:
a. lipid globules having a volume-weighted mode diameter of at least 1.0 μm, and/or
b. lipid globules, wherein at least 40 vol. % of said lipid globules have a diameter from 2 to 12 μm.; and
c) freeze-drying said emulsion to obtain the freeze-dried composition comprising:
a. lipid globules having a volume-weighted mode diameter of at least 1.0 μm, and/or
b. lipid globules, wherein at least 40 vol. % of said lipid globules have a diameter from 2 to 12 μm.

2. The process according to claim 1, wherein the oil-in-water emulsion obtained in step b) comprises:
a. lipid globules having a volume-weighted mode diameter of at least 2.0 μm, and/or
b. lipid globules, wherein at least 55 vol. % of said lipid globules have a diameter from 2 to 12 μm.

3. The process according to claim 1, wherein the aqueous phase is provided with a dry matter content of 5-75 wt. % by weight of the aqueous phase.

4. The process according to claim 1, wherein the lipid phase and aqueous phase are homogenized in a ratio of 5 to 50% (w/w) of the lipid phase to 95 to 50% (w/w) of the aqueous phase.

5. The process according to claim 1, wherein the homogenizing in step b) is carried out with a homogenization apparatus selected from a static mixer, an inline mixer, a rotor stator machine, a cavitator or by a membrane emulsification device.

6. The process according to claim 1, wherein the dry matter content of the oil-in-water emulsion is between 30-80 wt. % by weight of the emulsion.

7. The process according to claim 6, wherein the dry matter content of the oil-in-water emulsion is between 55-80 wt. % by weight of the emulsion.

8. The process according to a claim 1, wherein the freeze-drying in step c) encompasses:
c1) freezing the oil-in-water emulsion to obtain a frozen emulsion; and
c2) drying the frozen emulsion at a pressure of less than 6 mbar and at a temperature from at least 0° C. to at most 60° C.

9. The process according to claim 1, wherein the lipid globules in the freeze-dried composition have a volume-weighted mode diameter of less than 20 μm, preferably less than 15 μm.

10. The process according to claim 1, wherein the lipid globules in the freeze-dried composition have a volume-weighted mode diameter between 1.5-10 μm.

11. The process according to claim 1, wherein at least 40 vol. % of the lipid globules in the freeze-dried composition have a diameter from 2 to 12 μm.

12. The process according to claim 1, wherein the lipid phase and/or the aqueous phase comprise polar lipids.

13. The process according to claim 12, wherein the polar lipids are comprised in the coating of the lipid globules in the freeze-dried composition.

14. The process according to claim 1, wherein an oil-in-water emulsion is obtained in step b), having a lipid globule size distribution with a volume-weighted mode diameter that is between at least 0.1 μm and at most 1.6 μm lower than the desired volume-weighted mode diameter of the freeze-dried composition obtained in step c).

15. A freeze-dried composition selected from infant formula, follow-on formula or growing up milk, obtainable by a process according to claim 1.
